(19) United States
(12) Patent Application Publication
(10) Pub. No.: US 2025/0249627 A1
(43) Pub. Date: Aug. 7, 2025

(54) SARGASSUM ECOLOGICAL LUMBER MATERIAL

(71) Applicants: Andres de Antonio Simancas, Mexico City (MX); Raquel de Antonio Crespo, Homestead, FL (US)

(72) Inventors: Andres de Antonio Simancas, Mexico City (MX); Raquel de Antonio Crespo, Homestead, FL (US)

(21) Appl. No.: 18/432,001

(22) Filed: Feb. 4, 2024

(51) Int. Cl. B29C 45/00; B29C 35/16; B29C 45/13; B29C 45/17; B29C 45/18; B29C 45/72; B29C 45/73; B29C 45/74; B29K 1/00; B29K 23/00; B29L 7/00

(52) U.S. Cl. CPC B29C 45/0001; B29C 45/13; B29C 45/1742; B29C 45/18; B29C 45/7207; B29C 45/73; B29C 45/74; B29C 2035/1616; B29K 2001/00; B29K 2023/0641; B29K 2023/065; B29L 2007/002

(57) ABSTRACT

This invention introduces an ecological lumber material made from sargassum, consisting of 40% processed sargassum seaweed and 60% recycled plastics (Medium-Density Polyethylene and High-Density Polyethylene). The creation process involves drying and grinding sargassum, then blending it with recycled plastics to produce a sustainable alternative to conventional wood. Specialized equipment, including a hydraulic press with a piston and tamper, a shaping mold, and a telescopic structure for molding and cooling, is used to mix and mold the materials into durable, eco-friendly sargassum lumber. Precise injection machinery ensures consistent quality and structural integrity. This sargassum ecological lumber material suitable for construction, furniture, packaging, and applications in maritime, aviation, and automobile sectors, offers environmental advantages by utilizing sargassum overgrowths and reducing plastic waste, contributing significantly to conservation efforts.

### FIELD OF THE INVENTION

This invention belongs to the technical field of generating and obtaining construction materials, referred to in this invention as sargassum ecological lumber material, ranging from domestic to industrial levels. It involves the treatment of brown algae such as sargassum in combination with major pollutants of our seas and oceans, such as Medium Density Polyethylene (MDPE) and High-Density Polyethylene (HDPE).

In the industry of generating and obtaining construction materials that replace the use of 100% wood, a sargassum ecological lumber material (without wood) has been developed. This material is composed of sargassum as well as plastic waste, through a process in which said sargassum and plastic waste are collected from the seas and oceans. They are then subjected to a drying and grinding treatment, combined with a washing, and grinding process for medium and high-density polyethylene. These materials are used in a transformation process in a machine adapted for the manufacturing of these materials, in accordance with their manufacturing method.

### BACKGROUND OF THE INVENTION

In a bid to develop sustainable construction products with low environmental impact, this invention has been developed as a technologically viable solution for the revalorization of polluting waste in our seas and oceans. Such waste includes sargassum, a type of brown algae, which poses an increasing environmental challenge in many coastal regions of the world. While crucial for marine ecosystems, the excessive proliferation of algae has become problematic due to human activities such as nutrient runoff and climate change. Large masses of sargassum reaching shores can disrupt coastal habitats, negatively impact marine life, and hinder local tourism and fishing industries. A pressing concern is the accumulation of sargassum mixed with plastic waste, exacerbating the marine waste issue, and threatening delicate ecosystems. However, this invention aims to address this issue creatively and sustainably by transforming these otherwise burdensome plastic and algae wastes into eco-friendly composite wood and construction materials. In doing so, this invention significantly contributes to alleviating the negative environmental impacts of sargassum proliferation and to a cleaner, greener planet.

Furthermore, plastic pollution, that is, the widespread influx of plastic waste into our marine ecosystems, has triggered a devastating domino effect, endangering marine life, coastal economies, and the delicate balance of our environment. It is sobering to realize that plastics contaminating our oceans, primarily composed of various forms of polyethylene, can take a staggering 30 years or more to degrade. These plastics, intertwined with sargassum algae, are the dual components of the product, process, and machine that this application intends to claim.

Prior art describes sandwich-type materials for construction composed of a gypsum board and two commercial cardboard sheets, marketed, for example, under the brand Pladur®. However, these materials are not suitable for hanging squares, appliqués, etc.

Prior art also describes the use of sludge, sawdust, or cork as acoustic and thermal insulators. Additionally, the use of soaps or foaming agents to reduce the density of materials is known.

Spanish Patent ES 2505341 details the use of fibers from the aquatic plant Posidonia oceanica as an insulating material in construction products. However, this document does not detail the mechanical properties of the products and describes binding agents like calcium sulfate, cement, silicon dioxide/aluminum oxide, lime (calcium carbonate), soluble glass, phosphate binder, and synthetic resin binder.

European Patent Document EP 2840196 A1 describes a thermoacoustic insulating board comprising Posidonia and sheep's wool felts, where the mix is sprayed with a diluted starch solution and requires at least 6 days to obtain the construction element. However, this document does not detail the mechanical properties of the products.

Spanish Patent Application ES 2 935 306 describes a thermal, acoustic, and fireproof insulating material comprising crushed dead algae or aquatic plants, a plant binder, and an aqueous solution of an organic acid. The invention also describes a bio-cement obtained by wet mixing crushed dead algae or aquatic plants, a plant binder, and an aqueous solution of an organic acid.

International Patent Application WO 2023/180116 A1 describes a construction material comprising crushed dead algae or aquatic plants and a plant-based binder, characterized by comprising an aqueous solution of an organic acid. The use of an aqueous solution of an organic acid improves the material's mechanical properties and acts as an antimicrobial agent. The construction material of the invention can be used to manufacture prefabricated parts for modular buildings or as bio cement for sealing joints and fixatives.

The closest document in the prior art, disclosed by the Spanish Patent and Trademark Office under number ES 2 538 576, divulges a method for obtaining materials formed from residual fibers of Posidonia oceanica, and materials obtained with it. The invention relates to the development of veils or sheets of nonwoven fabrics from fibers derived from Posidonia oceanica waste, an endemic species of the Mediterranean coast, suitable for the manufacture of composite materials using hot thermocompression techniques. Specifically, the invention describes the nature of the veil-forming fibers, thermoplastic fibers, and ranges of compositions of residual fibers from Posidonia oceanica for obtaining easily manageable veils adaptable to various geometries through a hot thermocompression process. The auxiliary veil-forming fibers aid in the veil formation process, achieving high homogeneity in the final product, and the thermoplastic fibers used facilitate the modeling of the materials through the simultaneous application of pressure and temperature.

However, none of the aforementioned documents disclose the sargassum eco lumber material of the present invention, nor the process of obtaining such material and the specific machine for the manufacturing of this material with the method also described later in this patent application.

### SUMMARY

Addressing the sargassum problem requires innovative and sustainable solutions. The spirit of this invention not only addresses the removal of these algae from the environment but also provides a practical application for the collected biomass. By converting sargassum and plastic waste into eco-friendly wood and construction materials, the sargassum eco lumber material of this invention actively contributes to environmental conservation and supports a circular economy benefiting both coastal communities and the planet at large.

Our target market is primarily the construction, furniture, maritime, aviation, automobile, and packaging industries. These industries demand high-quality construction materials, versatile furniture components, and eco-friendly packaging solutions. Our Sargassum Eco Lumber Materials are designed to meet the needs of these sectors, providing them with a sustainable and innovative alternative to traditional materials like plywood.

Additionally, companies and individuals seeking more eco-friendly construction solutions and environmentally responsible products will also be part of our target market. As the demand for green and sustainable products grows, our sargassum ecological lumber materials present an attractive option for those looking to make a positive environmental impact while meeting their project requirements.

We could summarize the properties and benefits of the material of this invention as follows:
Isothermal: The unique composition of the sargassum ecological lumber material provides excellent thermal insulation properties, helping to maintain a comfortable and energy-efficient indoor environment.
Long-Lasting: Designed for durability, our sargassum ecological lumber material withstands the test of time and reduces the need for frequent replacements.
Non-Flammable: Thanks to its composition, the sargassum ecological lumber material is non-flammable, offering increased fire safety in construction applications.
Water-Resistant: Weather-resistant and resistant to water damage, our sargassum ecological lumber material remains structurally stable even in adverse weather conditions, making it ideal for both indoor and outdoor use.
Easy Workability: The sargassum ecological lumber material can be cut, sawn, and nailed effortlessly, facilitating installation for builders and contractors.
Termite-Resistant: Unlike conventional wood, our sargassum ecological lumber material is naturally resistant to termites, as they cannot digest this material, ensuring long-term protection against pest damage.
Self-Extinguishing: In case of exposure to fire, our sargassum ecological lumber material exhibits self-extinguishing properties, further enhancing its safety attributes.
Rot-Resistant: The sargassum ecological lumber material is resistant to rot, decay, and fungal growth, ensuring structural integrity and longevity.
Rust-Resistant: In coastal or humid environments, our sargassum ecological lumber material stands out for its resistance to rust and molecular degradation due to the action of ultraviolet rays from the light spectrum, making it an ideal choice for marine and coastal applications.
Versatility: The versatile nature of our sargassum ecological lumber material allows its use in a wide range of construction projects, from architectural features to furniture and decking.
Low Maintenance: With minimal maintenance requirements, the sargassum ecological lumber material saves time and resources, making it a practical and cost-effective option.
Contributes to the Circular Economy: By repurposing sargassum and recycled plastic waste, our sargassum ecological lumber material supports a circular economy model, closing the waste generation loop and promoting sustainability.
Reduces Ocean Pollution: By converting sargassum and plastic (MDPE and HDPE) into valuable construction materials, our sargassum ecological lumber material actively contributes to mitigating ocean pollution, benefiting marine life and coastal ecosystems.
Environmentally Friendly: By using sargassum and recycled plastic (MDPE and HDPE) as raw materials, our sargassum ecological lumber material significantly reduces the carbon footprint and contributes to a cleaner environment, preventing waste from ending up in landfills and oceans.

Therefore, one of the objectives of this invention is to produce a sargassum ecological lumber material without dust, vapors, or emissions. Recycling and reusing plastic (MDPE and HDPE) for cleaner planet.

In our commitment to environmental preservation, we take pride in our dry process, with zero reliance on fossil fuels or organic solvents, our production method ensures minimal ecological impact. Gone are the days of harmful emissions, as our process produces no dust, vapors, or smog, safeguarding the atmosphere and local air quality.

Another object of this invention is a dedication to sustainability that extends further as we repurpose plastic (MDPE and HDPE), a known pollutant, during our eco-friendly process. By transforming these plastic wastes into premium sargassum eco lumber material, we not only divert them from landfills but also contribute to reducing plastic pollution in the oceans and natural habitats.

Another object of this invention is that, apart from using sargassum as a plant contribution to the invention, it is also a modality to use other plant materials instead of sargassum, such as pine, oak, ash, or any other type of wood chips; materials like ground rice husks, nutshells, pistachio shells, olive pits, among others can also be used.

### BRIEF DESCRIPTION OF THE DRAWINGS

The figures accompanying this patent specification are as follows, which are demonstrative and not limiting:

FIG. 1 Shows a solid view of the material of the present invention.

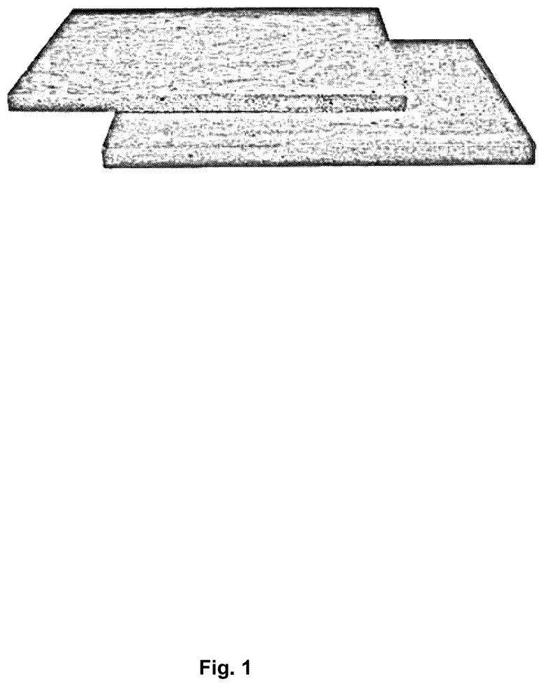

FIG. 2 Depicts a block diagram view representing and showing the process of obtaining and treating sargassum as a raw material for the creation of the sargassum ecological lumber material of the present invention.

FIG. 3 Illustrates a block diagram view representing and showing the process of obtaining and treating MDPE plastic as a raw material for the creation of the sargassum ecological lumber material of the present invention.

FIG. 4 Presents a block diagram view representing and showing the process of obtaining and treating HDPE plastic as a raw material for the creation of the sargassum ecological lumber material of the present invention.

FIG. 5 Displays a block diagram view representing and showing the process of obtaining the sargassum ecological lumber material of the present invention.

FIG. 6A Shows the machinery for manufacturing the sargassum ecological lumber material of the present invention in a side view. It should be noted that for clarity, only two of the six injection machines are shown in the figure.

FIG. 6B Depicts the machinery for manufacturing the sargassum ecological lumber material of the present invention in a top view, where all six injection machines of the present invention are included.

FIG. 6C Illustrates the machinery for manufacturing the sargassum ecological lumber material of the present invention in a solid view, for a better description of the invention.

### DETAILED DESCRIPTION

The present invention aims to maximize the use of waste from seas and oceans that have caused most of the pollution in our waters.

The increase of sargassum on our beautiful coasts is not just a passing concern; it is a growing challenge that demands our attention. Some cities are dedicating a substantial budget of 4 to 6 million dollars a year to keep clean beaches, but the problem persists. The question of what to do with the collected biomass remains unanswered.

Astounding figures reveal the magnitude of the sargassum challenge we face. According to NASA images, this year approximately 13 million tons of the notorious, foul-smelling algae have congregated in the Great Atlantic Sargassum Belt, underscoring the urgency to find effective and sustainable solutions. This is not just a local problem; it is a global concern that demands our collective action. Through innovation and collaboration, we can transform this challenge into an opportunity for positive change.

Recent studies have revealed a concerning discovery within the sargassum phenomenon. Researchers have found elevated levels of bacteria in sargassum algae, raising questions about its potential impact on marine ecosystems and public health. These findings underline the complex nature of the sargassum challenge and reveal the need for comprehensive approaches that address both its ecological implications and potential consequences for human interactions with coastal environments.

Our oceans face an ever-increasing crisis: the rampant proliferation of plastic waste. The staggering impact of plastic pollution on marine ecosystems cannot continue to be ignored. Plastics, primarily composed of materials like polyethylene, are infiltrating our waters at an alarming rate, suffocating marine life, disrupting ecosystems, and endangering our environment.

The real alarm is the longevity of these plastics. Polyethylene-based plastics, commonly used in single-use items, can take 30 years or more to degrade, subjecting our oceans to their harmful effects for decades. As they break down into microplastics, they penetrate deeper into the marine food chain, affecting aquatic life and potentially even reaching our plates.

The manufacturing process of sargassum ecological lumber represents a groundbreaking approach in the field of sustainable material production. This innovative process begins with the careful collection of sargassum, from beaches or the sea using existing market procedures, such as trucks, shovels, and tractors. Once collected, the algae undergo a drying process using a conveyor belt machine with a stepped design. This machine acts as a tunnel with cylindrical parabolic solar heaters on the roof, heating thermal oil (PARATHERM) to temperatures of up to 330 degrees Celsius.

Medium and high-density polyethylene plastic (MDPE and HDPE), sourced from bags, packaging, and supermarket waste, is first densified with heat, and then ground in a blade mill. It is then combined with the dried and ground sargassum. This mixture is then introduced into a molding machine to create sheets or synthetic wood materials.

To prevent deformation of the sheet or material, it is essential to cool it simultaneously across its entire surface. For this, the press along with the mold is submerged in cold water.

Subsequently, the sheet or material is sized, the edges are cut, and it undergoes a sanding process to achieve the final finished product.

Our process involves melting MDPE and HDPE plastic, which encapsulates the ground sargassum particles. As the plastic polymer melts and solidifies, it encapsulates any heavy metal particles present in the sargassum, effectively trapping them within the matrix.

The environmental benefits of our process are twofold. Firstly, it provides a valuable industrial application to sargassum, effectively eliminating the presence of this algae from our beaches. Secondly, it reuses and gives industrial use to plastic waste (MDPE and HDPE) sourced from bottle caps, wrappers, and other medium and high-density polyethylene materials, preventing their decomposition or open-air burning, and reducing emissions of harmful substances like dioxins, methane, and CO2.

Furthermore, impurities such as sand grains and calcium carbonate compounds (CO3CA) are often found in sargassum. These impurities are soft and inert and, during the melting process, also become trapped within the polymeric matrix.

The state-of-the-art sargassum ecological lumber material manufacturing machine we intend to protect in this invention application can process an impressive amount of sargassum efficiently. In just 24 hours, this machine can produce an astonishing 48 tons of materials, for example, panels of 1,222 mm×2,444 mm (4×8 feet), or 1,222 mm×3,050 mm (4×10 feet), and sargassum represents 60% of the total weight. This translates to approximately 28,800 kilograms of sargassum processed daily per machine.

However, the beauty of our solution lies in its scalability. If the demand for the final product, the eco lumber materials, increases, we have the flexibility to install additional machines. This means we can ramp up production to meet market demands and process even larger amounts of sargassum. In doing so, we not only contribute to environmental conservation but also cater to the growing demand for sustainable construction materials.

Our adaptable manufacturing process allows us to meet the needs of an environmentally conscious market and contribute to building a more sustainable future.

In our commitment to environmental preservation, we take pride in our dry process, with zero reliance on fossil fuels or organic solvents, our production method ensures minimal ecological impact. Gone are the days of harmful emissions, as our process produces no dust, vapors, or smog, safeguarding the atmosphere and local air quality.

Our dedication to sustainability extends further as we repurpose plastic (MDPE and HDPE), a known pollutant, during our eco-friendly process. By transforming these plastic wastes into premium sargassum ecological lumber material, we not only divert them from landfills but also contribute to reducing plastic pollution in the oceans and natural habitats.

At the heart of our innovation is a multi-step process that harmoniously combines cutting-edge technology with environmental responsibility. Our journey begins with the Solar Drying System, meticulously designed to reduce the moisture content of the sargassum to an optimal 14%. This dry sargassum, now free of excess water, undergoes a crucial grinding phase before being carefully stored in sturdy sacks within silos.

What sets our process apart is its profound impact on hygiene and sustainability. During the solar drying phase, the sargassum is sterilized, eradicating potentially harmful bacteria that could cause unwanted fermentation. This sterilization process, achieved through controlled exposure to heat, ensures that the final product meets the highest quality standards.

But our innovation doesn't stop here: it extends to strategic resource management. During peak times of sargassum arrival on the country's coasts, our system operates at full capacity. The ability to process substantial volumes of sargassum, dry it, grind it, and store it effectively for future use during scarcity represents an ingenious way of managing this natural resource; also, and without deviating from the scope of the invention, to use as a plant contribution instead of sargassum, materials such as pine, oak, ash, or any other type of wood chips; materials like ground rice husk, ground nutshells, pistachio shells, olive pits, among others, can also be used.

At the center of our transformative journey lies the main engine of our success: the molding machine. This innovative machine works tirelessly and can generate benefits 24 hours a day, 360 days a year. The molding machine is where the magic happens, where sargassum and recycled plastic come together to form the basic components of a more sustainable future.

In a first aspect of the invention, a sargassum ecological lumber material is described, said material is composed of 60% plastic, specifically, a mix of medium-density polyethylene (MDPE 30%) and high-density polyethylene (HDPE 30%), and the remaining 40% is sargassum, previously prepared.

The sargassum ecological lumber material is manufactured through a long but efficient process of obtaining and preparing the raw materials as explained below:

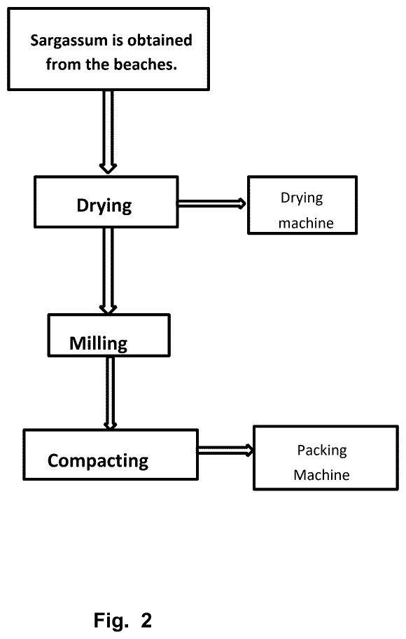

As shown in FIG. 2, first, the presence of sargassum is located on the beaches, which is then removed from these beaches to undergo a drying process. This is carried out using a conveyor belt dryer (not shown) with a stepped design. This machine acts like a tunnel with cylindrical parabolic solar heaters on the roof, which heat thermal oil (PARATHERM) to temperatures of up to 330 degrees Celsius. Photovoltaic solar panels are used in this dryer, so that based on solar thermal energy, a flow of hot air is circulated over the sargassum to dry it.

Once the sargassum is dry, it enters a grinding process where smaller particles of sargassum are obtained. After being ground, it is compacted into “bales” as if it were cattle feed, ready for transportation and storage at the location where it will be processed along with the plastic.

It should be noted that the drying process and preparation into “bales” is done “in situ,” which means that if it is necessary to transport this raw material to distant places for the manufacture of the eco lumber material, time, money, and effort are saved, as the material is dry and occupies less volume and weight for transportation.

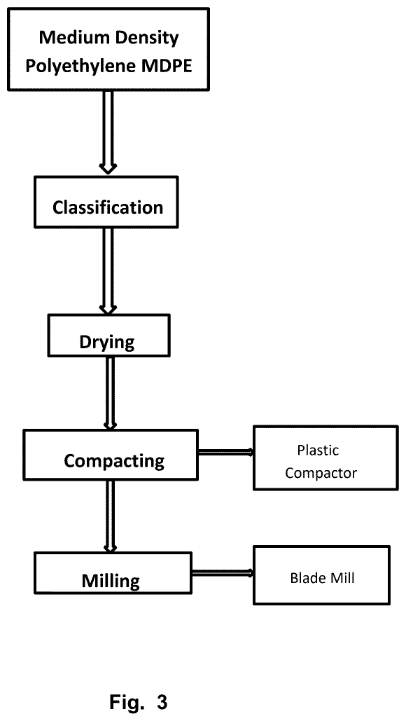

As illustrated in FIG. 3, Medium Density Polyethylene (MDPE) plastic, sourced from bags, packaging, and supermarket waste, among others; like the sargassum, this plastic (MDPE) is recovered from beaches to give a second use to these polluting elements. First, the plastic is sorted to obtain only this raw material, that is, to segregate materials or elements that are not plastics such as other pollutants, then it is dried (as much as possible) and fed by gravity into a hopper, which directs the plastic (MDPE) to a compacting machine (not shown). This compacting machine through an auger, moves the plastic through a cylinder, where the cylinder is heated externally by any known means, and as the plastic passes through the hot cylinder, it heats up, losing its moisture and “agglomerating” to form a plastic paste, which is expelled at the end of the cylinder to fall into a water container, cooling the paste; once the paste is cold, it solidifies and is sent to a grinding process in a blade mill (not shown), where this mix of plastics (MDPE) is ground to obtain small particles of recycled plastic, which are stored and/or transported in 1 cubic meter containers for storage and transport to the next step of the process.

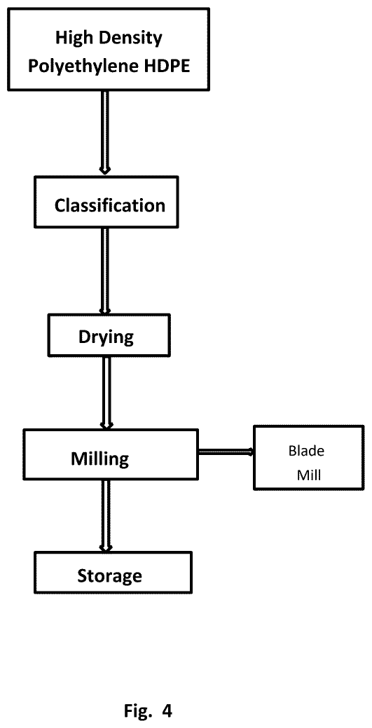

FIG. 4 illustrates the process for obtaining and processing another raw material for the creation of sargassum ecological lumber material. This raw material is high-density polyethylene (HDPE) plastic, which comes from sources such as plastic screw caps, water bottles, milk bottles, plastic boxes, among others. This HDPE plastic is also recovered from beaches to repurpose these polluting elements. Initially, the plastic is sorted to isolate this specific raw material, meaning separating any non-plastic materials or other pollutants. After drying it as much as possible, it is fed by gravity into a hopper, which directs the HDPE plastic to a mill (not shown). In the mill, the HDPE is ground to produce small particles of recycled plastic, which are then stored or transported in 1 m³ containers for storage and transport to the next stage of the process.

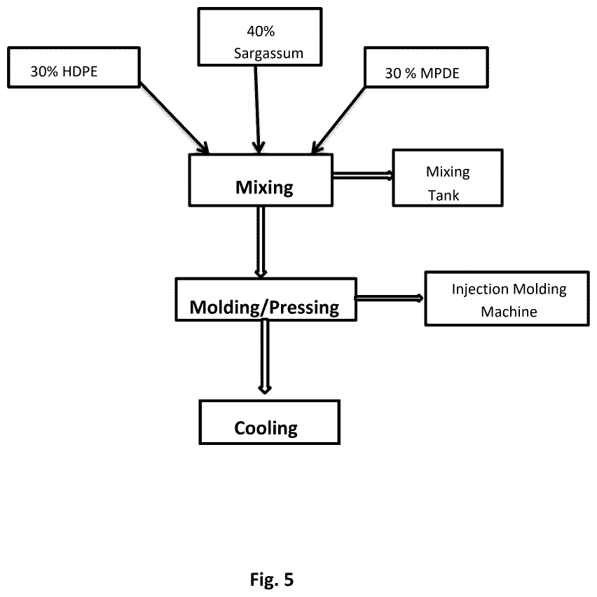

The process to create the sargassum ecological lumber material is shown in FIG. 5. The first step involves mixing the three raw materials that make up the eco lumber material. These are introduced into a mixing “kettle” (not shown) in the following proportions: 40% dry and ground sargassum, 30% medium-density polyethylene (MDPE) plastic, and 30% high-density polyethylene (HDPE) plastic, making up 100% of the sargassum eco lumber material. Once the three raw materials are mixed, the molding process begins. The mixture of the three raw materials is poured into plastic injection machines, where it is melted and then poured into a mold set up in a pressing or molding machine. The material mixture is then pressed using a piston to the required dimensions designed by the size and shape of the mold. After pressing, the mixture is cooled in a water container. Finally, the material is ejected from the mold to cool to ambient temperature outside of the water. If the material obtained is in the form of plates, it is arranged between metal plates for stacking.

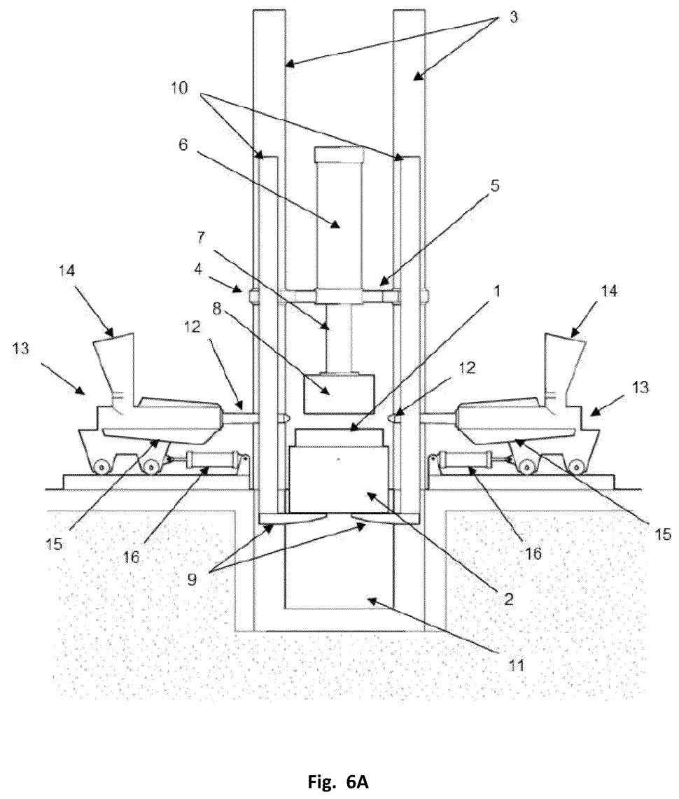

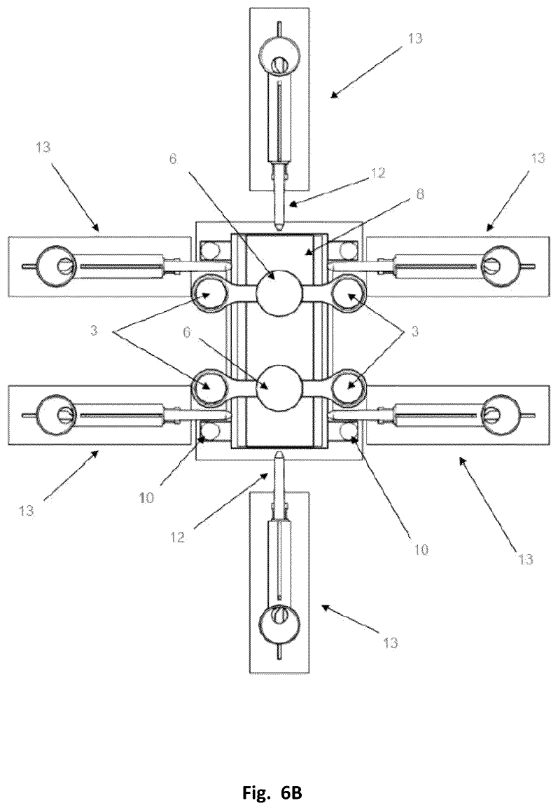

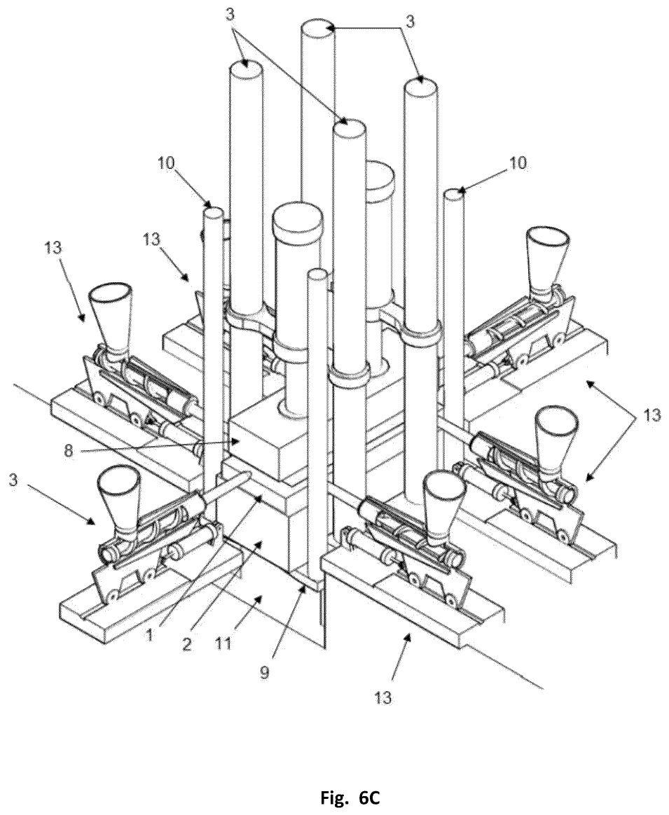

As described in FIGS. 6A, 6B, and 6C, a mold (1) is supported above an oil reservoir (2). This oil reservoir is arranged to operate an ejection mechanism (not shown) to extract the sargassum ecological lumber material from the mold (1). This mold (1) and oil reservoir (2) are supported by a support and displacement structure, consisting of at least two support columns (3), preferably four columns. Bearings (4) slide on each of these support columns (3), connected to a support structure of a press (5). This press is comprised of a hydraulic cylinder (6) housing a piston (7), which at its lower end holds a plate or tamper (8) that moves up or down to apply pressure to the mold (1), as further described later.

This support and displacement structure also includes support plates (9), which support the oil reservoir (2) and the mold (1) situated above the oil reservoir (2). The support plates (9) are connected to a telescopic descending and lifting structure (10), located within a pit or water tank (11). This water can be cooled or aerated by any known method to maintain a constant temperature throughout the water tank (11). During the manufacturing process of the sargassum ecological lumber material, this descending and lifting structure (10) positions or maintains the press (5) in the first position or molding position, where the molding process of the sargassum eco lumber material takes place, which will be detailed later. There is also a second position or cooling position, where after the molding of the sargassum ecological lumber material, the descending and lifting structure (10) lowers the press (5) to introduce it into the water tank (11), thus cooling the sargassum eco lumber material inside the mold (1). Once the mold (1) has cooled to a pre-designed temperature, the descending and lifting structure (10) raises the press (5) to the first position or elevated position to extract the sargassum eco lumber material from the mold through an ejection mechanism (not shown) placed beneath the mold (1), to continue the cooling process of the sargassum eco lumber material outside of the mold (1) and press (5).

Returning to the first position of the descending and lifting structure (10), in this elevated position, the molding process of the sargassum ecological lumber material is carried out. The molding process takes place inside the mold (1), which is rectangular in shape, like the tamper (8) as shown in FIG. 6B. As depicted in FIGS. 6A, 6B, and 6C, at least six nozzles (12) from at least six injection machines (13) simultaneously pour the mixture of raw materials into the mold (1). More specifically, these injection machines (13) include a mixer or hopper (14) where the previously mentioned percentages of raw materials are poured, i.e., 30% HDPE, 30% MDPE, and 40% sargassum into the hopper (14). These materials, by gravity, enter a heating chamber (15), where the mixture of the three raw materials is heated and fused to form a homogeneous paste. Also, inside this heating chamber (15) is an auger (17), which is rotated by an external motor. This auger (17) mixes and moves the mixture from one side to the other of the heating chamber (15), directing the mixture to the nozzle (12) for injection onto the mold (1).

The injection machines (13) have an attraction and retraction mechanism (16) at their ends to draw the injection machine (13) towards or away from the mold (1); that is, when the press is outside the water tank, in the first elevated position of the descending and lifting structure (10) or during the molding process, this attraction and retraction mechanism brings the injection machine (13) closer to the mold so that the injection nozzle (12) pours the mixture onto the mold (1). Once the mixture is injected, the attraction and retraction mechanism (16) withdraw or displaces the injection machine (13) away from interaction with the mold (1).

During the molding process, as seen in FIGS. 6A, 6B, and 6C, the tamper (8) descends with the force and pressure exerted by the pistons (7) inside the cylinders (6). More specifically, in FIGS. 6B and 6C, the six injection machines (13) are shown injecting the sargassum ecological lumber material mixture into the mold (1). As seen in these figures, two of the injection machines (13) inject the mixture through one long side of the mold (1), another two injection machines (13) inject the mixture through the other long side of the mold (1), one of the six injection machines (13) injects the material through one of the short sides of the mold, and the sixth and final injection machine (13) injects the mixture on the other short side of the mold, correctly filling the mold so that the tamper (8) begins to descend and exert pressure on the mixture, thus forming a plate of sargassum ecological lumber material inside the mold.

Once the mold (1) is filled with the mixture and the tamper (8) has exerted the required pressure to form the plate of sargassum ecological lumber material, the cylinders (6) stop and maintain the pressure exerted by the tamper (8). At that moment, the press (5) descends by the means already described towards the water tank (11) to start the cooling process.

It should be noted that during the cooling process of the sargassum ecological lumber material plate within the mold (1), the injection machines (13) continue processing the mixture of raw materials. This allows for the commencement of a new molding process within the mold after the sargassum ecological lumber material plate is extracted from the mold (1). This cycle continues until the desired production of sargassum eco lumber material plates is achieved.

Finally, it is crucial to highlight that the movements and controls of the machinery and equipment used in the manufacturing process of the sargassum ecological lumber material of this invention are managed through PLCs (Programmable Logic Controllers), motors, servomotors, and other elements known for this purpose according to the state of the art.

1. A sargassum ecological lumber material comprising a mix of plant-based and plastic materials, characterized in that the mix is composed of a plant-based material such as sargassum in 40% of the mix, said sargassum being previously dried and ground, in addition to 60% plastic material, where the plastic material is made up of 30% medium-density polyethylene (MDPE) and 30% high-density polyethylene (HDPE).

2. The sargassum ecological lumber material according to claim 1, characterized in that the plant-based material can be from the group consisting of pine, oak, ash wood chips, and/or any other type of wood; materials such as rice husk, ground nutshells, pistachio shells, olive pits, among others, and/or a mix of the same can also be used.

3. The sargassum ecological lumber material according to claim 2, characterized in that the plant-based material can be a mix of the materials and sargassum.

4. The sargassum ecological lumber material according to claim 1, characterized in that the material can be in the form of rectangular plates with dimensions of 1,222 mm×2,444 mm (4×8 feet), or 1,222 mm×3,050 mm (4×10 feet) in different thicknesses.

5. A process for obtaining a sargassum ecological lumber material according to claim 1 comprising of preparing the plant-based material such as sargassum through a process of drying, grinding, and compacting. Preparing the medium-density polyethylene (MDPE) plastic material through a process of classification, drying, agglomeration, and grinding. Preparing the high-density polyethylene (HDPE) plastic material through a process of classification, drying, and grinding. Mixing the plant-based material such as sargassum, the medium-density polyethylene (MDPE) plastic, and the high-density polyethylene (HDPE) plastic, introducing these materials into a hopper towards an injection machine. Molding the sargassum ecological lumber material, this molding includes injecting the mix of sargassum materials, medium-density polyethylene (MDPE) and high-density polyethylene (HDPE) into a mold (1) and pressing said material in the mold (1) placed in a press. Once the material mix has been subjected to a certain pressure, cooling the material still inside the mold in a water tank (11). Continuing the cooling process by extracting the material from the mold (1) and cooling it to ambient temperature.

6. An equipment for obtaining a sargassum ecological lumber material through the process of obtaining said material in accordance with claim 5, said equipment comprises: a mold (1) that is supported above an oil reservoir (2), this mold (1) and oil reservoir (2) are supported by four support columns (3), on which a bearing (4) slides on each of the columns, these bearings are connected to a support structure of a press (5) which is comprised of a hydraulic cylinder (6), this hydraulic cylinder (6) houses a piston (7), which at its lower end holds a plate or tamper (8) that moves up or down to apply pressure on the mold (1); support plates (9) support the said oil reservoir (2) and the mold (1) which is located above the oil reservoir (2); the support plates (9) are connected to a telescopic descending and lifting structure (10), this descending and lifting structure (10) is located inside a pit or water tank (11), this descending and lifting structure (10) maintains the press (5) in the first position or molding position, a position above the water level of the water tank (11); and a second position or cooling position, a position inside the water tank (11), once the mold (1) is cooled, the descending and lifting structure (10) raises the press (5) to the first position or elevated position to extract the sargassum eco lumber material from the mold through an ejection mechanism (not shown); six nozzles (12) from at least six injection machines (13) are arranged around the periphery of the mold (1), these injection machines (13) include a mixer or hopper (14) and a heating chamber (15), where the mixture of the three aforementioned raw materials is heated and fused, forming a homogeneous paste, directing this paste or mixture to the nozzle (12) for injection onto the mold (1); these injection machines (13) have an attraction and retraction mechanism (16) at their ends to draw the injection machine (13) towards or away from the mold (1), this attraction and retraction mechanism (16) withdraws or displaces the injection machine (13) away from interaction with the mold (1).

7. The equipment for obtaining a sargassum ecological lumber material in accordance with claim 6, characterized in that the water in the water tank (11) can be cooled or aerated by any known method to maintain a constant temperature throughout all areas of the said water tank (11).

8. The equipment for obtaining a sargassum ecological lumber material in accordance with claim 7, characterized in that the movements and controls of the machinery and/or elements used within the process of manufacturing the sargassum eco lumber material of this invention are managed through PLCs (Programmable Logic Controllers), motors, servomotors, and known elements.
